(19) United States
(12) Patent Application Publication
(10) Pub. No.: US 2009/0299887 A1
(43) Pub. Date: Dec. 3, 2009

(54) SYSTEM AND METHOD FOR DETECTING SAVINGS OPPORTUNITIES BASED ON THE PRICE PROTECTION AND RETURN POLICIES OF RETAILERS

(76) Inventors: Maya Shiran, Pittsburgh, PA (US); Tomer Shiran, Pittsburgh, PA (US); Yehuda Shiran, Haifa (IL); Alon Shiran, Haifa (IL)

Correspondence Address: Tomer Shiran, 18 Martin Buber St, Haifa, 34861, omitted

(21) Appl. No.: 12/132,607

(22) Filed: Jun. 3, 2008

(51) Int. Cl. G06Q 30/00

(52) U.S. Cl. 705/35

(57) ABSTRACT

A system and method is disclosed for detecting savings opportunities for consumers based on the price protection and/or return policies of retailers, following a process of purchasing items from online or physical retailers. The system receives an order statement which comprises information about an order, such as an identifier of the retailer, a date and the details of one or more purchases, where each purchase includes at least an identifier of an item and the amount paid for that item. The system then extracts that information from the order statement, without requiring the user to specify the details of each purchase separately. The system continuously monitors the prices of the items and the conditions specified in the retailer's price protection and/or return policies. If the system determines that the customer is eligible to receive a refund or can profit from returning an item to the retailer and re-purchasing it (perhaps from a different retailer), it either requests the refund from the retailer on behalf of the customer, or notifies the user.

### TECHNICAL FIELD

The present invention relates generally to a system and method for detecting savings opportunities for consumers. More particularly, the present invention relates to a system and method for detecting savings opportunities for consumers based on the price protection and/or return policies of retailers.

### BACKGROUND OF THE INVENTION

Many consumers use the Internet to purchase products and services from online retailers. Many physical (i.e., brick-and-mortar) retailers, such as Wal-Mart and Best Buy, also have online services (located at http://www.walmart.com/ and http://www.bestbuy.com/, respectively) that enable consumers to purchase their items without needing to visit their physical stores. A retailer that wishes to advertise and sell items online typically provides an electronic catalog that lists the items that are available, as well as their prices. A consumer can easily access the Web site of a retailer to find the current price of an item that is available from that retailer.

Consumers can use online price comparison services to find the retailer that is currently offering a specific item for the lowest price. Most price comparison services utilize technology that scans the Web sites of retailers for prices and stores them in a database. When users search for an item, the price comparison service displays a list of retailers that offer that item, as well as their current prices for that item. They can then purchase the item at the lowest available price among all retailers supported by the service. Although in many cases there are additional opportunities to save money after purchasing an item (due to price decreases), none of the existing price comparison services address such opportunities.

### SUMMARY OF THE INVENTION

Customers can often save money after purchasing an item from a retailer by taking advantage of the retailer's return policy. After purchasing the item, if the retailer's price decreases within the allowed return period, the customer can return the item and re-purchase it at the new price. Furthermore, a customer who purchases an item from one retailer, and later finds the same item available at a lower price at a different retailer, can return the item to the original retailer and then purchase it from the other retailer (whose price is lower). A retailer's return policy specifies the conditions that apply to returning a purchased item and receiving a refund.

In recent years, many retailers have also begun offering price protection. There are generally two different types of price protection, herein referred to as non-matching protection and matching protection:
1) Non-matching protection: The retailer states that if its price on an item decreases during a given period after the item was purchased, the retailer will refund the difference.
2) Matching protection: The retailer states that if the customer finds the same item at a lower price at a different retailer during a given period after purchasing the item, the original retailer will match the price by refunding the difference to the customer. Some retailers advertise an even greater offer, such as a “115% price protection,” indicating they will refund the difference plus 15%, thus giving the customer an even deeper discount. In practice, almost all retailers that offer matching protection also offer non-matching protection, although the opposite is not necessarily true.

Price protection policies don't cost retailers much. Few customers are conscientious enough to review advertised prices after a purchase and request a refund. Therefore, the retailer rarely has to make good on its price guarantee.

An embodiment of the present invention provides a system and method for detecting savings opportunities based on the price protection and return policies of retailers. After purchasing one or more items from a retailer, the system of the present invention receives the order statement from the user or directly from the retailer. The order statement may be, for example, an order confirmation email, an order confirmation Web page or a digital copy of a printed receipt. Upon receiving the order statement, the system parses it and extracts the necessary information, such as an identifier of the retailer, an order date and details of one or more purchases. Each purchase includes an identifier of an item, the quantity and the price paid for that item. The system saves this information in a database.

The system of the present invention monitors the prices of items at a number of retailers, looking for opportunities to take advantage of price protection and return policies for each purchase in the database. When the system finds that an item is available for less than what the user paid, and all the conditions of the original retailer's price protection or return policies are met, the user may be notified. Alternatively, the system may request a refund from the retailer on behalf of the user.

The system may prioritize exploiting the retailer's price protection policy over exploiting the return policy, since requesting a refund usually requires less effort than returning a product and purchasing it again (whether from the same retailer, or from a different one). However, when the price protection policy cannot be exploited, due to some restriction in the policy, the user may be notified of opportunities to exploit the return policy (if such opportunities exist).

With respect to prior art, including existing online services, patent applications and issued patents, the present invention is novel in several aspects:
1) The present invention introduces a method for detecting savings opportunities based on a retailer's price protection policy, which may not require users to provide information about their purchases on a Web site, and may not require them to separately enter each item that they purchase. In addition, the user may not need to separately specify the date of the order or the amounts paid for the items in the order. Instead, the system of the present invention may receive an order statement and may generally automatically extract all of the necessary information from the statement. An order statement herein may comprise, for example, an order confirmation email. Regardless of how the system actually receives the order statement, the present invention dramatically reduces the user's effort to a level at which the user may not even be required to know what items were in the order, or how many, as the information is extracted generally automatically from the order statement. The present invention describes several novel methods by which the system can receive order statements. The following are non-limiting examples of such methods:
   a) After completing an order, the user receives an order confirmation email from the retailer. The user then forwards the email to an email address that is associated with the system of the present invention, such as save@afteryoubuy.com (assuming that the domain name afteryoubuy.com is mapped to the system).
   b) The user first establishes a so-called “shopping email address” on the Web site of the system of the present invention. The shopping email address is associated with the system, so any email that is sent to this address reaches the system. A user named John Doe might establish the email address jdoe@afteryoubuy.com (assuming that the domain name afteryoubuy.com is mapped to the system). In addition to establishing a shopping email address, the user may provide his or her real email address. From this point on, whenever purchasing items from online retailers, the user may provide his or her shopping email address to the retailer's Web site. Any order confirmation email sent by a retailer provided with the shopping email address may first reach the system of the present invention, and optionally may then be forwarded by the system to the user's real email address. The system generally automatically extracts order information from any order confirmation email that it receives without requiring user input.
   c) Rather than requiring the user to establish a shopping email address, the system accesses the user's real email account. It scans the user's emails and detects those that are order confirmation emails from retailers that the system supports. The system may be integrated with an email service, such as Google Gmail™, thereby allowing it to access the email accounts hosted by that email service. Alternatively, users may provide their email account credentials to the system, thereby allowing the system to access their email accounts, regardless of where they are hosted.
   d) The system retrieves the user's order statements from the supported retailers. This may require the system to have permission to access the user's accounts on the retailers' Web sites or Web services. In such cases, the user first provides the necessary credentials to the system.

Other methods of receiving order statements are also within the scope of the invention.
2) The present invention introduces a method for automatically requesting a refund from a retailer, on behalf of a user, when that user is entitled to receive the refund based on the retailer's price protection policy. This method may involve, for example, sending an email to the retailer, submitting a form on the retailer's Web site or using a retailer's Web service, if available.
3) The present invention introduces a method for detecting savings opportunities based on a retailer's return policy (rather than its price protection policy). This method may provide significant value, because return policies are sometimes more flexible than price protection policies.
4) The present invention introduces a method for providing price comparison among retailers for an item, while taking price protection into account. This method may utilize historical data, such as previously detected savings opportunities based on the price protection policies of different retailers. There are many ways in which the price comparison can utilize such data. For example, it may compute an estimated refund for each retailer (the estimate may depend on the item or the category of the item).

There is thus provided in accordance with an embodiment of the present invention, a method performed by a computer-based system, for identifying savings opportunities. The method includes having an order statement, extracting order information from the order statement, the order information including a retailer identifier corresponding to a retailer, an order date and at least one purchase, each purchase including an item identifier and a price that was paid for the item, and checking if a savings opportunity exists on any of the items in the order information.

Additionally, in accordance with an embodiment of the present invention, the checking includes considering any of a return policy of the retailer and a price protection policy of any of the retailer and at least one other retailer.

Moreover, in accordance with an embodiment of the present invention, the order statement is any of an order confirmation email and a digital copy of a printed receipt.

Furthermore, in accordance with an embodiment of the present invention, the having includes the retailer sending the order confirmation email to any of an email address controlled by a user and an email address controlled by the computer-based system.

Still further, in accordance with an embodiment of the present invention, the having further includes receiving the order confirmation email forwarded by the user from the email address controlled by the user.

Additionally, in accordance with an embodiment of the present invention, the having further includes accessing an email account corresponding to the email address controlled by the user, and retrieving the order confirmation email.

Moreover, in accordance with an embodiment of the present invention, the having further includes receiving credentials from the user, wherein the accessing further includes authenticating with the credentials.

Furthermore, in accordance with an embodiment of the present invention, the having further includes the computer-based system forwarding the order confirmation email received from the retailer at an email address controlled by the computer-based system, to an email address controlled by the user.

Still further, in accordance with an embodiment of the present invention, the retailer sending an order confirmation email to an email address controlled by the computer-based system further includes the user establishing the email address on a Web site associated with the computer-based system.

Additionally, in accordance with an embodiment of the present invention, the extracting includes performing optical character recognition (OCR) on the digital copy.

Moreover, in accordance with an embodiment of the present invention, the order statement is an order confirmation email and the computer-based system is a Web-based email service.

Furthermore, in accordance with an embodiment of the present invention, the method further includes requesting information from the user if the extracting does not provide all information needed.

Still further, in accordance with an embodiment of the present invention, the having includes receiving the order statement on any of a Web site and a Web service associated with the computer-based system.

Additionally, in accordance with an embodiment of the present invention, the having includes retrieving the order statement from any of a Web site and a Web service associated with the retailer.

Moreover, in accordance with an embodiment of the present invention, the method further includes receiving credentials from a user, wherein the retrieving includes authenticating with the credentials.

Still further, in accordance with an embodiment of the present invention, the checking includes retrieving the current price of the item from any of a Web site and a Web service of any of the retailer and at least one other retailer.

Furthermore, in accordance with an embodiment of the present invention, the checking includes retrieving the current price of an item from a database that contains up-to-date prices of items at different retailers.

Additionally, in accordance with an embodiment of the present invention, the method further includes the computer-based system requesting the retailer to provide a refund to the customer if any savings opportunity exists.

There is thus provided in accordance with an embodiment of the present invention, a method performed by a computer-based system, for identifying savings opportunities. The method includes having purchase information, wherein the purchase information includes a retailer identifier corresponding to a retailer, an item identifier corresponding to an item, a purchase date and a price that was paid for the item, and checking if the customer can save money by returning the item to the retailer and re-purchasing it from any retailer.

Additionally, in accordance with an embodiment of the present invention, the checking further includes considering costs associated with returning the item to the retailer.

There is thus provided in accordance with an embodiment of the present invention, a method, performed by a computer-based system, for providing a price comparison of an item. The method includes determining the price of an item at multiple retailers, and providing a price comparison, wherein the price comparison includes, for each of the multiple retailers, the price of the item and additional information related to any of the price protection policy and the return policy of the retailer.

Additionally, in accordance with an embodiment of the present invention, the additional information is an estimated future refund.

Moreover, in accordance with an embodiment of the present invention, the expected refund is computed based on refunds that customers were entitled to receive from the retailer in the past.

Furthermore, in accordance with an embodiment of the present invention, the additional information includes the likelihood that the customer will be entitled to a refund on the item in the future.

There is thus provided in accordance with an embodiment of the present invention a computer-based system for identifying savings opportunities. The system includes a front-end component to receive an order statement and to extract order information from the order statement, a database for storing the order information and an opportunity detector component to check if a savings opportunity exists for any of the items in the database, wherein the order information includes a retailer identifier corresponding to a retailer, an order date and at least one purchase, each purchase including an item identifier and a price that was paid for the item.

Additionally, in accordance with an embodiment of the present invention, the front-end component includes an email server and the order statement is an order confirmation email.

There is thus provided in accordance with an embodiment of the present invention a computer-based system for identifying savings opportunities. The system includes an extractor to extract order information from an order statement, and a checker to determine if a savings opportunity exists on any of the items in the order information.

Additionally, in accordance with an embodiment of the present invention, the order statement is received from the retailer at any of an email address controlled by a user and an email address controlled by the computer-based system.

Moreover, in accordance with an embodiment of the present invention, the order statement is received from the user from an email address controlled by the user.

Furthermore, in accordance with an embodiment of the present invention, the order statement is received at an email address controlled by the computer-based system wherein the user established the email address on a Web site associated with the computer-based system.

Still further, in accordance with an embodiment of the present invention, the order statement is an order confirmation email and the computer-based system is a Web-based email service.

Additionally, in accordance with an embodiment of the present invention, the system further includes a user interface to request information from the user if the extractor does not provide all information needed.

Moreover, in accordance with an embodiment of the present invention, the checker considers costs associated with returning the item to the retailer.

### BRIEF DESCRIPTION OF THE DRAWINGS

FIG. 1 is an illustration of the price protection and return policies of Zappos.com, an exemplary online shoe retailer;

FIGS. 2A and 2B are exemplary illustrations of the price points which may be compared, wherein FIG. 2A uses a system of the prior art and FIG. 2B uses an embodiment of the present invention;

FIG. 3 is an illustration of an exemplary printed receipt;

FIG. 4 is an illustration of an exemplary order statement;

FIG. 5 is a block diagram of the usage of the present invention operative in accordance with an embodiment of the present invention;

FIG. 6A is a block diagram of a method for collecting order statements, operative in accordance with an embodiment of the present invention;

FIG. 6B is a block diagram of a method for checking for savings opportunities, operative in accordance with an embodiment of the present invention;

FIG. 7 is a block diagram of a method for collecting order statements in which the user forwards an order confirmation email to the system, operative in accordance with an embodiment of the present invention;

FIG. 8 is a block diagram of a method for collecting order statements in which the user creates a digital copy of a printed receipt and sends the digital copy to the system by email, operative in accordance with an embodiment of the present invention;

FIG. 9 is a block diagram of a method for collecting order statements in which the user copies the content of an order confirmation email and submits it to the system via a Web site, operative in accordance with an embodiment of the present invention;

FIG. 10 is a block diagram of a method for collecting order statements in which the user creates a digital copy of a printed receipt and submits it to the system via a Web site, operative in accordance with an embodiment of the present invention;

FIG. 11 is a block diagram of a method for adding a new item to the item database, operative in accordance with an embodiment of the present invention;

FIG. 12 is a block diagram of a method for keeping the item database up to date with the most recent (i.e., current) prices, operative in accordance with an embodiment of the present invention;

FIG. 13 is a block diagram of a method for checking for savings opportunities by taking advantage of a retailer's price protection policy, operative in accordance with an embodiment of the present invention;

FIG. 14 is a block diagram of a method for checking if Zappos.com will match a competitor's price on a purchased item, operative in accordance with an embodiment of the present invention;

FIG. 15 is a block diagram of a method for checking for savings opportunities by taking advantage of a retailer's return policy, operative in accordance with an embodiment of the present invention;

FIG. 16 is a block diagram of a method for collecting order statements by accessing a user's online account, operative in accordance with an embodiment of the present invention;

FIG. 17 is a block diagram of a method for collecting order statements in which the system receives the retailer's order confirmation email directly from the retailer, operative in accordance with an embodiment of the present invention;

FIG. 18 is an illustration of an exemplary Web-based email service, operative in accordance with an embodiment of the present invention;

FIGS. 19A and 19B are illustrations of price comparison Web sites, wherein FIG. 19A uses a system of the prior art and FIG. 19B uses an embodiment of the present invention.

### DETAILED DESCRIPTION OF THE INVENTION

The present invention provides a system and method for detecting savings opportunities based on the price protection and return policies of retailers. In one embodiment, the system of the present invention reduces the number of user interactions needed to begin monitoring the purchases of an order. After purchasing one or more items from a retailer, the user of the system supplies the order statement that was provided by the retailer. The order statement may be, for example, an order confirmation email, an order confirmation Web page (i.e., the Web page that the retailer displays after approving the user's payment) or a digital copy of a printed receipt. Alternatively, the system may receive the order statement directly from the retailer. In this case, the order statement may be, for example, an order confirmation email (which the system receives directly from the retailer), a Web page on the retailer's Web site showing the user's previous orders or the output of a Web service that retrieves the user's previous orders. In these cases, unlike prior art systems, the user may not need to explicitly enter the details of the order, since the system may be able to extract such information from the order statement. For example, the system may extract an identifier of the retailer, an order date and details of one or more purchases (each purchase may include an identifier of an item, a quantity and the price paid for that item).

This functionality is significantly different from existing online price protection services, such as PriceProtectr.com, RefundPlease.com, Amazon Price Watch (www.nukeprice.com) and AmazingRefund.com, because such services require the user to manually enter each item that he or she purchased (by specifying either its URL or unique identifier, such as an ISBN or ASIN). In fact, since both the date and the item's price may change between the time the item is purchased and the time the user provides the information to the online price protection service, the user is usually required to specify the purchase date and price. The system of the present invention, on the other hand, may be capable of extracting all the necessary information directly from the order statement.

After extracting the order information from the order statement, the system stores that information in a database so that it can track the purchases in the order for as long as the retailer's price protection or return policies remain in effect (on items that were purchased). During that period, the system generally continuously seeks opportunities to exploit the retailer's price protection and return policies. This involves monitoring the prices of the items in the order at the original retailer and possibly other retailers. It may also involve checking other conditions (i.e., restrictions) set forth in the retailer's price protection and return policies, because such conditions must be met in order for the user to receive a refund (according to the price protection policy) or return a product (according to the return policy).

When determining if the user can profit from returning the product and re-purchasing it, perhaps from a different retailer, the system may consider the cost of returning the product. This may include not just direct costs, such as shipping and transportation expenses, but also some quantification of the user's inconvenience and lost time.

If the system determines that the user is entitled to receive a refund or has a chance to profit from returning an item and re-purchasing it, it notifies the user. In some cases, if the user is entitled to receive a refund (according to the price protection policy), the system may be able to request the refund without involving the user, thereby further reducing the user's effort compared to existing online price protection services.

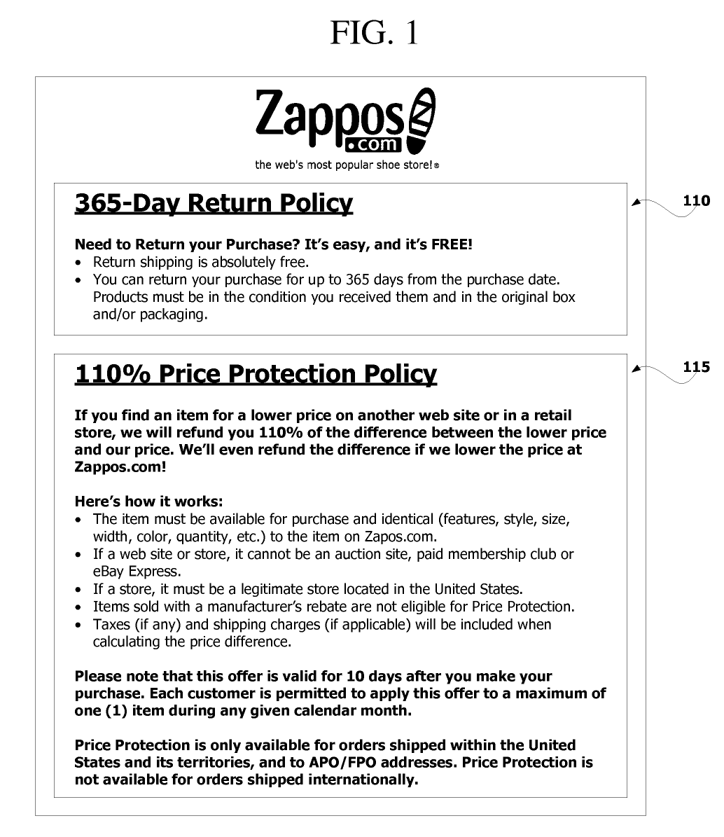

FIG. 1, to which reference is now made, is an illustration of the price protection and return policies of Zappos.com, an exemplary online shoe retailer. According to the price protection policy, shown in area 115, the retailer offers a 110% price protection, meaning that if the customer purchases an item and finds it at a lower price at another retailer, the customer will receive 110% of the difference between the lower price and the original price. Zappos.com also promises to refund the difference if it lowers its own price on that item. To summarize, Zappos.com provides both non-matching and matching protection.

Zappos.com's price protection policy also lays out a series of conditions that customers must meet in order to receive refunds in accordance with the price protection policy. For example, the item must be in stock at the other retailer, and must be identical (in features, style, size, width, color and quantity). In addition, Zappos.com does not match auction sites, paid membership clubs or eBay Express, and does not match foreign physical stores. Zappos.com also specifically states that items sold with a manufacturer's rebate are not eligible, and that any taxes and shipping charges at another retailer are counted towards the other retailer's price of the item. Finally, Zappos.com's price protection is valid for 10 days after purchasing an item. In other words, a customer cannot request a refund if more than 10 days have passed.

The return policy of Zappos.com, shown in area 110, introduces yet another opportunity for customers to save money if better prices become available after purchasing items. Zappos.com offers free shipping in both directions; that is, customers do not need to pay for shipping when ordering an item or returning one. The only conditions in the return policy are that the item must be in its original condition and must be returned within 365 days.

Even if more than 10 days (the duration of the price protection) have passed since purchasing an item, customers can take advantage of the return policy to achieve the same result. For example, if a customer purchases an item and the price decreases 30 days later, then if the item is still in its original condition, the customer can return it and re-order it from Zappos.com, thereby pocketing the difference between the lower price and the original one. A customer can use a similar approach if the item becomes available at a lower price at a different retailer. By returning the item to Zappos.com and then purchasing it at the other retailer, the customer can save money.

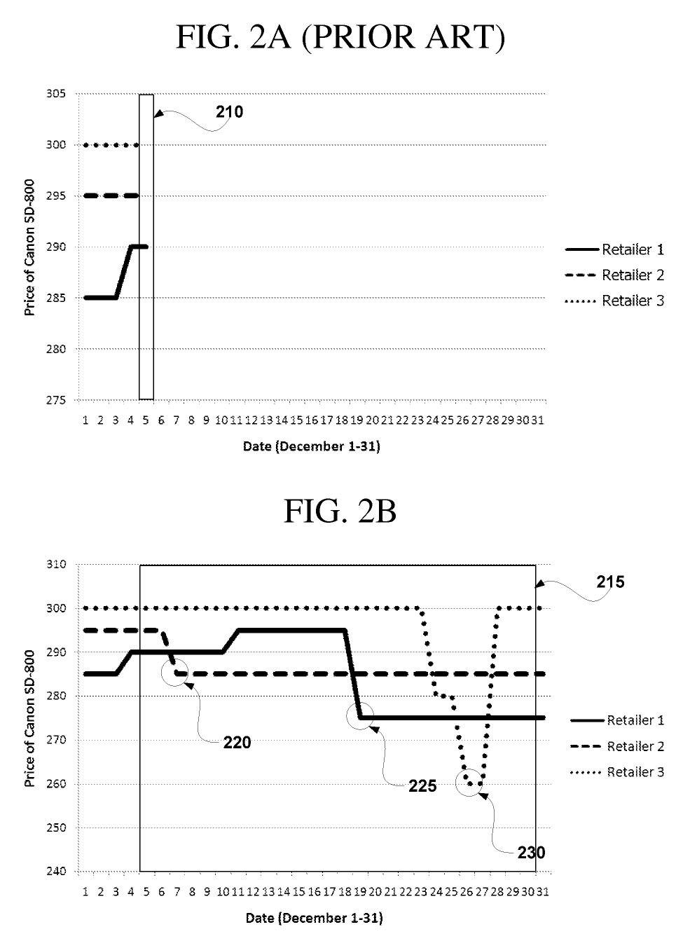

FIGS. 2A and 2B, to which reference is now made, are exemplary illustrations of the price points which may be compared, wherein FIG. 2A uses a system of the prior art and FIG. 2B uses an embodiment of the present invention. FIGS. 2A and 2B each contain three lines, representing the price of the Canon SD-800 digital camera at three different retailers during the month of December. We assume that the customer wants to purchase the camera on December 5, and that Retailer 1 offers a 25-day price protection (matching protection) with no additional conditions.

In FIG. 2A, the user uses a price comparison service of the prior art to find the retailer offering the lowest price on December 5. Figuratively, the service helps the user find the lowest price point within area 210, which comprises the prices of each of the retailers on December 5: $300, $295 and $290 (reflecting Retailer 3, Retailer 2 and Retailer 1, respectively). The user purchases the camera from Retailer 1 for $290, because $290 is the lowest price available that day.

In FIG. 2B, the system of the present invention is used to exploit the price protection policy of Retailer 1 (from which the user purchased the camera), helping the user to effectively achieve the lowest price point during the 25 days following the purchase (the prices for the period are shown in area 215). Figuratively, the user can achieve the lowest price point in area 215, which is $260 (offered by Retailer 3 on December 26-27). On December 7, Retailer 2 drops its price to $285 (shown as point 220), and the user is entitled to receive a $5 refund from Retailer 1 in accordance with the price protection policy of Retailer 1. On December 19, Retailer 1 drops the price to $275 (shown as point 225), and the user is entitled to receive an additional $10 refund from Retailer 1. On December 26, Retailer 3 drops its price to $260 (shown as point 230), and the user is entitled to receive an additional refund of $15. Assuming no other price decreases occur within the price protection period, the user is able to achieve an effective price (after multiple refunds) of 290-5-10-15=$260, equal to the lowest price point (shown as point 230) available while the original retailer's price protection was intact.

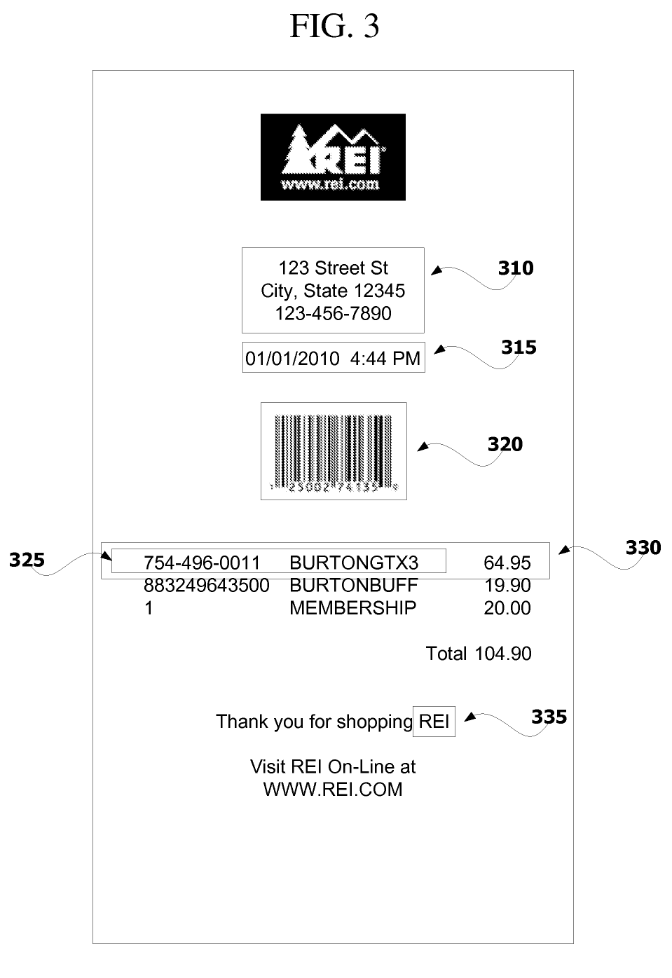

FIG. 3, to which reference is now made, is an illustration of an exemplary printed receipt belonging to a physical (i.e., brick-and-mortar) retailer named REI (which also sells online). The receipt contains information about a customer's transaction at an REI store. Area 310 contains the address and phone number of the store. Area 315 contains the date and time of the purchase, and area 320 contains the transaction number. The receipt includes identifiers of the retailer in several places, such as area 335. The receipt includes three different purchases, each consisting of one item. A purchase may include an identifier of an item, a quantity and the price paid for the item. For example, purchase 330 relates to an item identified as BURTONGTX3 and 754-496-0011. Both identifiers (BURTONGTX3 and 754-496-0011), which are shown in area 325, may be considered retailer-specific item identifiers, because different retailers may use different identifiers for the same item. The price of purchase 330 was $64.95, and the quantity was one (the quantity is not shown in FIG. 3, because in most cases it is assumed that the quantity is one unless explicitly indicated otherwise). This receipt contains two other purchases, relating to the items identified as BURTONBUFF (or 883249643500) and MEMBERSHIP.

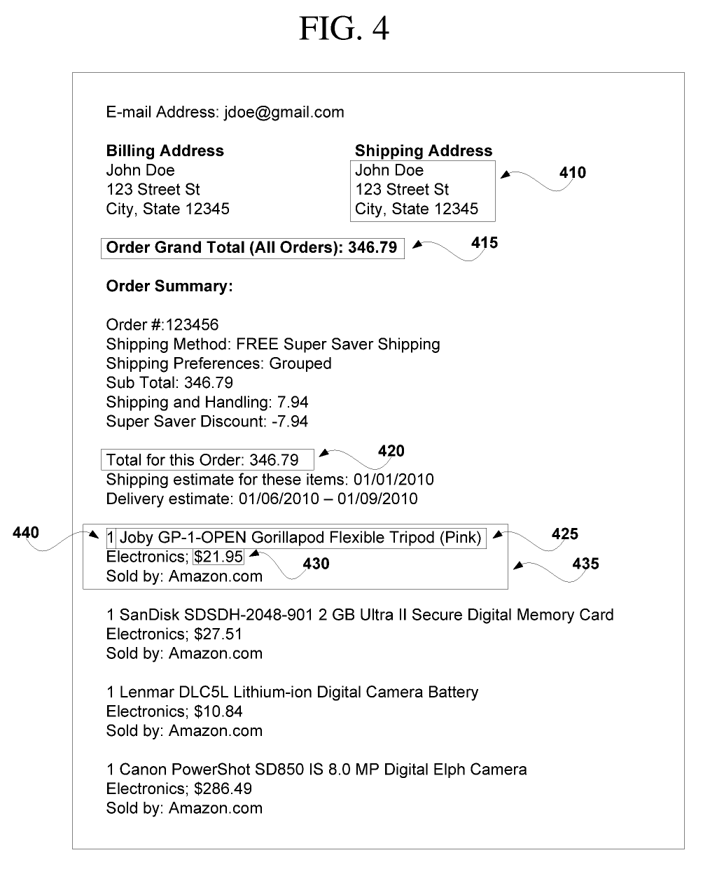

FIG. 4, to which reference is now made, is an illustration of an exemplary electronic receipt, or order confirmation email, belonging to an online retailer named Amazon.com. When consumers purchase items online, the retailer typically provides an email confirming the details of their order. Retailers also typically present a dynamic Web page at the end of the process, which contains similar information to an order confirmation email. A customer can then print or save the Web page.

Area 410 contains the customer's shipping address. Area 420 contains the total price of the order, including all purchases. Area 435 contains one of the four purchases in the order, relating to an item identified in area 425 as “Joby GP1-OPEN Gorillapod Flexible Tripod (Pink)” (this is a retailer-specific item identifier of this item at Amazon.com). Area 440 shows the quantity which is “1.” Area 430 shows the price of this purchase, which was $21.95. Area 415 contains the order grand total, which would be different from area 420 if this order confirmation email consisted of multiple independent orders (in which case area 415 would contain the total of all orders).

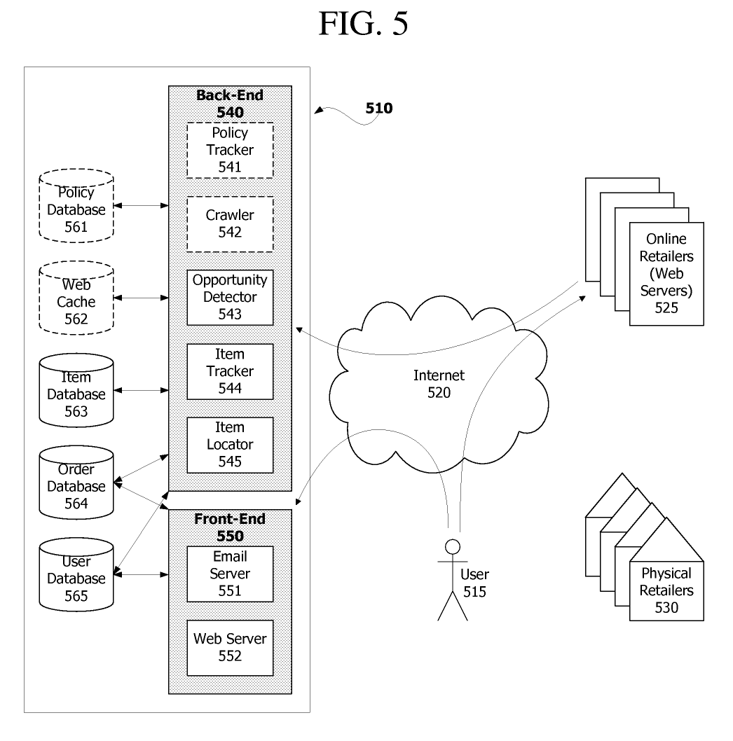

FIG. 5, to which reference is now made, is a block diagram of the usage of the present invention, operative in accordance with an embodiment of the present invention. User 515 purchases items from online retailers 525 and physical (i.e., brick-and-mortar) retailers 530. Online retailers 525 comprise both “online-only” retailers and the Web sites of physical retailers. After a purchase from a retailer, system 510 may receive an order statement from the user or the retailer. The system monitors the prices and conditions related to the retailer's price protection and return policies. The online retailers and the system are all connected to Internet 520. The user may use a client device, such as a personal computer or mobile phone, to connect to the Internet in order to interact with online retailers 525 and system 510.

System 510, an embodiment of the present invention, may comprise back-end 540, front-end 550, optional policy database 561, optional Web cache 562, item database 563, order database 564 and user database 565. Front-end 550 may be primarily responsible for interacting with users. For example, users may provide order statements to front-end 550. Back-end 540 may be primarily responsible for interacting with online retailers 525 and identifying opportunities to exploit their price protection and return policies. The front-end may comprise email server 551 and Web server 552. When a user forwards a retailer's order confirmation email to system 510, it is received by the email server. Alternatively, when the user provides an order statement via the system's Web site, it is received by the Web server. When the front-end receives order statements, the necessary information is extracted and stored in order database 564. Front-end 550 may also interact with user database 565 for the purpose of managing user accounts. For example, front-end 550 may store a user's contact information (e.g., email address) in user database 565.

The back-end may comprise optional policy tracker 541, optional crawler 542, opportunity detector 543, item tracker 544 and item locator 545. Policy tracker 541 may monitor retailers' Web sites and may detect changes in the Web pages that describe the retailers' price protection and return policies. When such changes are detected, the system's operator may be automatically notified by the system so that the revised policies can be integrated into the system as soon as possible. In a further embodiment of the present invention, the revised policies may be entered and used by the system without requiring any human intervention. Policy database 561 may store a representation (e.g., full copy, cryptographic hash) of these Web pages so that policy tracker 541 may compare the most recent version of the Web page with the version that the system is currently using.

Crawler 542 may be responsible for crawling retailers' Web sites and retrieving the Web pages of items that are being offered. The crawler is similar to standard crawlers known in the art that are used by search engines, except that it is primarily interested in the Web pages of retailers (and only those that the system supports).

Opportunity detector 543 is responsible for monitoring prices and evaluating the conditions of relevant price protection and return policies, in order to identify opportunities for users to save money (by receiving a refund or returning an item and re-purchasing it). The opportunity detector may comprise the logic of the actual price protection and return policies of the supported retailers. This logic may be either manually or automatically derived from the policies stored in policy database 561.

Item tracker 544 is responsible for keeping item database 563 up to date. For each item in the item database, the item tracker periodically retrieves the latest price from retailers that sell that item. The item database may contain retailer-specific information for each item. For example, it may store the URL of the retailer's listing of the item. It may also store one or more item identifiers that the retailer uses to refer to that item. This is important because an order statement includes an item identifier for each purchase and it is not uncommon for different retailers to use different item identifiers for the same item.

Item locator 545 is responsible for processing the item identifiers received in order statements and stored in order database 564. For example, the item locator checks if the item corresponding to the item identifier is already in the item database. If the item identifier cannot be found in the item database, item locator 545 retrieves the retailer's listing of the item and creates a new entry in the item database with the details of the item that were found on the retailer's Web site. These details enable item tracker 544 to more easily find the same item on the Web sites and Web services of other retailers.

It is worth noting that system 510 doesn't necessarily need all of the components that are shown in FIG. 5. For example, the system might not have policy tracker 541 and policy database 561, in which case the system's operator would need to identify changes to retailers' price protection and return policies. The system might also not require crawler 542 and Web cache 562, because it may be able to retrieve an item's details, for example, by searching for the item's Web page via a retailer's search engine or one or more third-party search engines, such as Google. It is also worth noting that the components of system 510 may be distributed among many different physical machines which may be located in different locations. Other embodiments will be obvious to those skilled in the art and are comprised in the scope of the present invention.

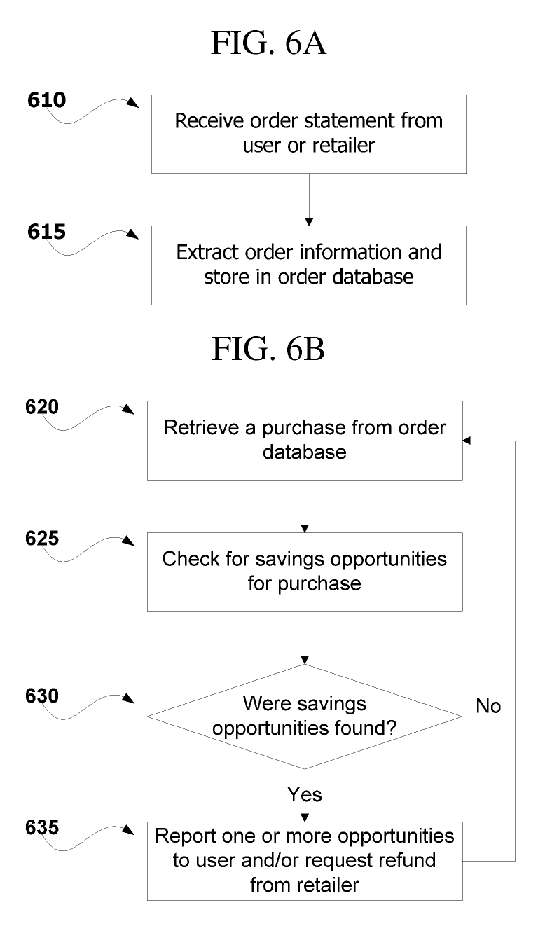

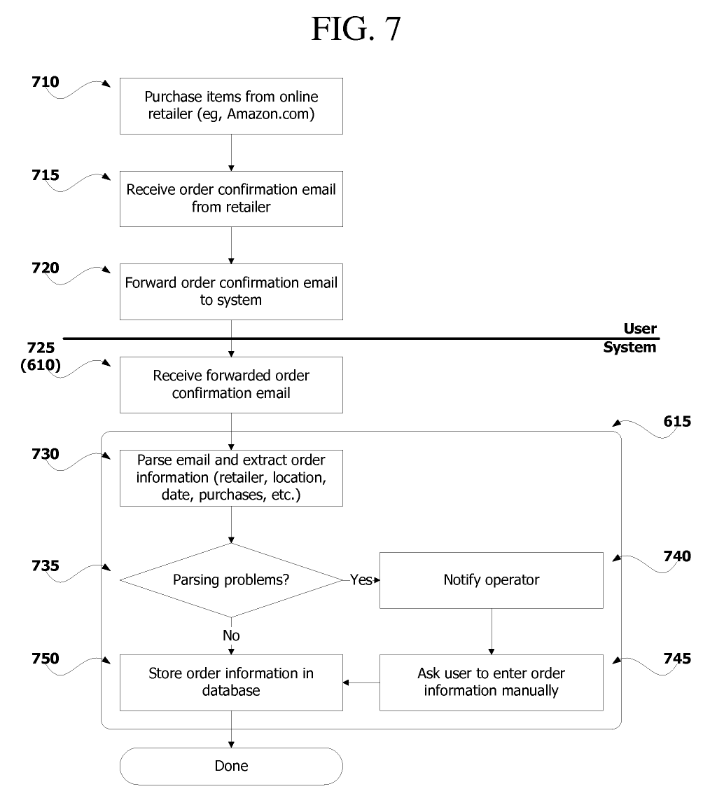

FIG. 6A, to which reference is now made, is a block diagram of a method for collecting order statements, operative in accordance with an embodiment of the present invention. In step 610, front-end 550 receives an order statement corresponding to a specific order (or multiple related orders). In step 615, the system extracts the order information from the order statement that it received. The extracted information comprises an identifier of the retailer, an order date and details of one or more purchases (each purchase comprises an identifier of an item, a quantity and the price paid for that item). All this information is then stored in order database 564. FIG. 6A is described herein below in greater detail with respect to FIGS. 7-10.

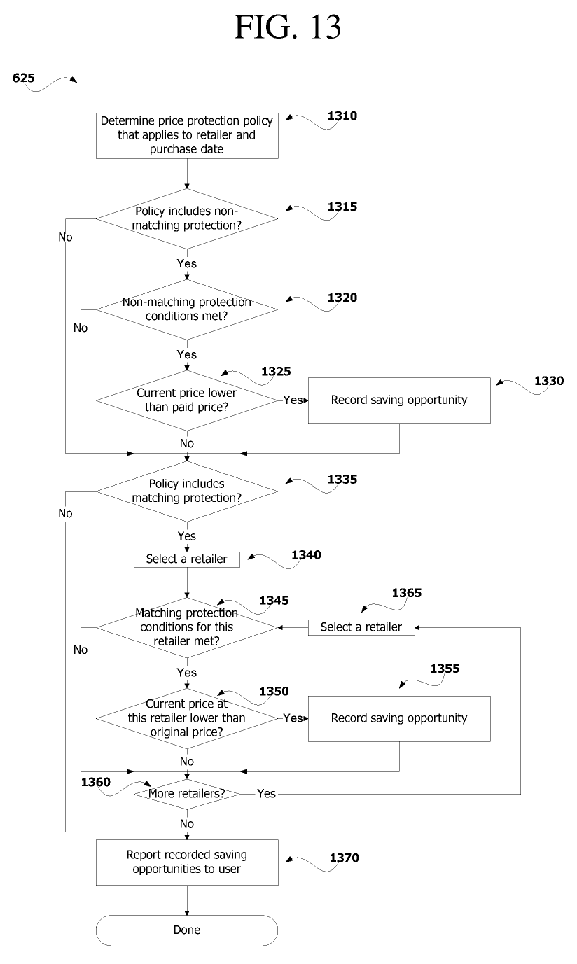

FIG. 6B, to which reference is now made, is a block diagram of a method for checking for savings opportunities, operative in accordance with an embodiment of the present invention. This method may execute at pre-determined intervals or in response to specific events (e.g., when a new order statement is received by front-end 550). Alternatively, it may execute generally continually at all times, checking for opportunities as often as possible. In step 620, the back-end retrieves the details of a purchase from order database 564. In step 625, it checks if there is currently an opportunity for the user to receive a refund, according to the retailer's price protection policy, or if the user can profit from returning the product and re-purchasing it (possibly from a different retailer), according to the retailer's return policy. In reality, step 625 is likely to involve several components of system 510 and many operations would be required. FIGS. 13-15 herein below provide more details on step 625. In step 630, if savings opportunities were found, the system continues to step 635. Otherwise, the system returns to step 620 in order to start a new iteration with a different purchase. In step 635, the system tells the user (whose purchase was retrieved in step 620 of the current iteration) about one or more savings opportunities that were found. Furthermore, if the user is entitled to receive a refund according to the price protection policy of the retailer, the system may automatically ask the retailer to provide the refund. Finally, the system returns to step 620 in order to start a new iteration with a different purchase. The cyclical process illustrated in steps 620-635 may iterate over each purchase that is stored in order database 564, except for those whose price protection and return periods have already expired. In an embodiment of the present invention, back-end 540 can process multiple purchases in parallel. In another embodiment of the present invention, back-end 540 combines the processing of all purchases that belong to the same order.

FIG. 7, to which reference is now made, is a block diagram of a method for collecting order statements in which the user forwards an order confirmation email to the system, operative in accordance with an embodiment of the present invention. Steps 710-720 are carried out by a user of the system, whereas steps 725-750 are carried out by the system's front-end 550. In step 710, the user shops online and purchases one or more items (i.e., products or services) from an online retailer, such as Amazon.com. When the user completes the transaction, the retailer sends the user an order confirmation email with the details of the order (e.g., date, shipping address, purchases, total price), and in step 715, the user receives the order confirmation email. In step 720, the user simply forwards the order confirmation to a known email address that is associated with the system's front-end. The user may use any email application to forward the order confirmation email, such as a desktop application (e.g., Microsoft Outlook™), mobile phone application (e.g., the internal mail application on Apple iPhone™) or Web mail (e.g., Google Gmail™). In fact, some email applications can be configured to automatically forward email messages that match certain rules. Thus, in a further embodiment of the present invention, users can configure their email applications to automatically forward order confirmation emails from the retailers that are supported by system 510 to the system's known email address.

The method of FIG. 7 implements step 610 of FIG. 6A as step 725, and step 615 of FIG. 6A as steps 730-750. In step 725, the front-end receives the user's forwarded order confirmation email. In step 730, it parses the email and extracts the necessary order information. The retailer's identity may be determined, for example, by extracting the “From” or “Subject” fields of the original order confirmation email (the original email is fully contained in the forwarded email). For example, when Amazon.com sends an order confirmation email to a customer, the “From” field may comprise “auto-confirm@amazon.com” and the Subject field may comprise “Your Order with Amazon.com.” These fields, which are part of the order statement, are considered “retailer identifiers” because the system may use them to identify the retailer.

In addition to the retailer's identity, the system extracts the purchases (item, quantity and price), date and other relevant information. To do this, the system may parse the body of the email according to pre-defined parsing instructions that are capable of identifying the necessary information within the email. The system may need different parsing instructions for each order confirmation email format used by the supported retailers. Alternatively, the system may use automated or semi-automated extraction techniques that do not require the system to know the formats of every possible order confirmation email. Such techniques are well known in the art and include, for example, natural language processing and machine learning. In step 735, if the system was unable to extract all the necessary information, it continues to step 740. Otherwise, it proceeds to step 750, in which the extracted information is stored in order database 564. In step 740, the system's operator receives a notification so that the problem can be investigated at a later time. This may, for example, be an indication that the retailer has changed the format of its order confirmation emails, or added a new format. In step 745, the system sends the user an email asking the user to access the system's Web site (hosted by Web server 552) and enter the needed order information manually. Although in some cases the system may be unable to extract any order information from the order statement, in other cases the system may be able to extract a portion of the necessary information. In such cases, the user may be requested to provide only the missing information. It is worth noting that a system of the present invention may determine that it needs additional information from the user only at a later stage. For example, if an order statement consists of ambiguous item identifiers (e.g., the item identifiers are item names, and the retailer has multiple items with the same name), the system may be unable to determine the correct item to monitor without requesting the user to resolve the ambiguity manually. It is also worth noting that a system of the present invention might not have the capability to allow the user to manually enter order information.

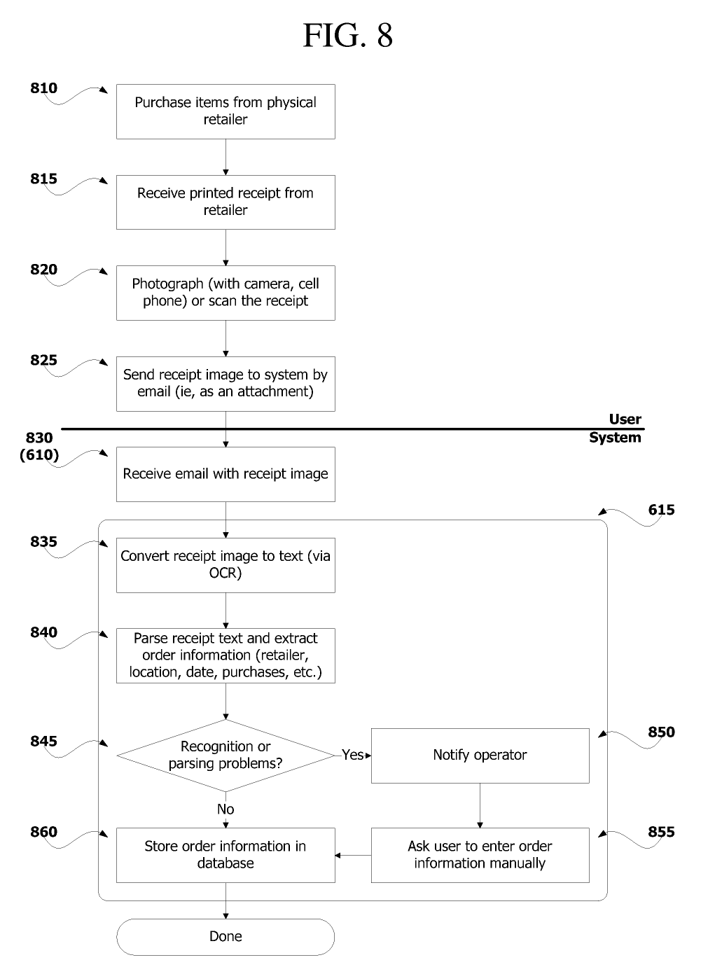

FIG. 8, to which reference is now made, is a block diagram of a method for collecting order statements in which the user creates a digital copy of a printed receipt and sends it to the system by email, operative in accordance with an embodiment of the present invention. This method is very similar to that illustrated in FIG. 7, but it enables users who shop at physical retailers to utilize the system with minimal effort (assuming that those retailers also have online stores or Web services, so that system 510 can monitor their prices). Most physical retailers give their customers printed (i.e., paper) receipts, similar to the one shown in FIG. 3. They typically do not send order confirmation emails, so a customer of a physical retailer cannot simply forward an email to the system as described in connection with FIG. 7.

In step 810, the user shops at a physical retailer and purchases one or more items. In step 815, the user is handed a printed receipt which contains information regarding the transaction, similar to an order confirmation email. In step 820, the user converts the printed receipt into digital format, such as JPEG (e.g., by digitally photographing or scanning it). For example, users may use the digital cameras of their mobile phones to photograph the printed receipt. In step 825, the user sends the resulting image to the system by email. Front-end 550 may accept digital copies of printed receipts, possibly at the same email address as forwarded order confirmation emails. Recent mobile phones, such as Apple iPhone, enable users to take photos and send them by email in a matter of seconds, thereby making the process much easier than explicitly entering each of the purchases into the system, as required by all prior art online price protection services.

Processing images (i.e., photographs or scans) of printed receipts is more complex than processing order confirmation emails, because the images must first be accurately converted into text via optical character recognition (OCR). This may introduce uncertainties or problems in the parsing phase (due to inaccuracies in the conversion), so it is more likely that the user may be required to enter some of the information manually. The method of FIG. 8 implements step 610 of FIG. 6A as step 830, and step 615 of FIG. 6A as steps 835-860. In step 830, the system's front-end (via email server 551) receives the user's email with the attached receipt image. In step 835, the system converts the image to text via any appropriate optical carriage recognition (OCR) system known in the art. The remaining steps, 840-860, are generally identical to steps 730-750 of FIG. 7, except that the order information is extracted from the text derived from the image, rather than the text of the email itself.

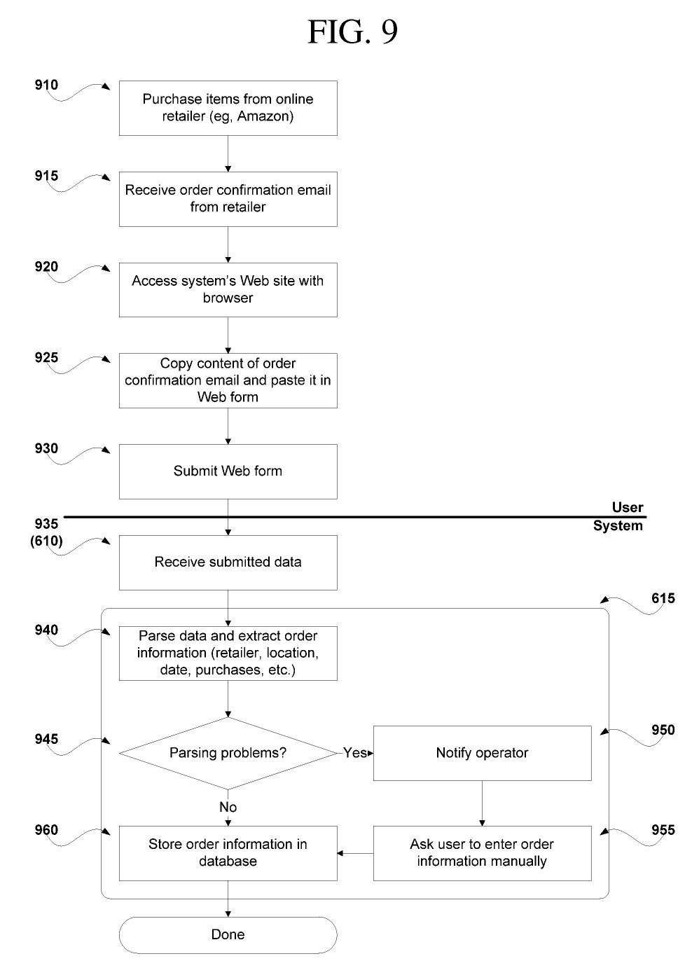

FIG. 9, to which reference is now made, is a block diagram of a method for collecting order statements in which the user copies the content of an order confirmation email and submits it to the system via a Web site, operative in accordance with an embodiment of the present invention. Although forwarding the order confirmation email to email server 551 of front-end 550, as shown in FIG. 7, is probably the most convenient option for users, there are situations in which they may prefer to submit the content of an order confirmation email via the system's Web site (hosted by Web server 552). One advantage of enabling a user to submit the content of an order confirmation email on the Web site is that the system may allow the user to provide additional information, such as alternative contact details (e.g., a mobile phone number so that the system can send the user an SMS message if it detects a savings opportunity for that user). Another benefit to submitting the content of the order confirmation email on the Web site is that the system can immediately respond to the user and request additional information or clarifications, as needed. Referring briefly back to FIG. 7, in step 745 the system sends the user an email, asking the user to access the system's Web site in order to provide information that the system was unable to extract from the order confirmation email. When submitting the content of the order confirmation email via the system's Web site (as shown in FIG. 9), this process becomes simpler and more direct. Furthermore, if a potential user visits the system's Web site and learns about the service for the first time, it may be more convenient to simply copy the content of an order confirmation email and paste it in a given Web form on the site.

In step 910, the user purchases one or more items from an online retailer. In step 915, the user receives an order confirmation email from the retailer, and in step 920, the user accesses the system's Web site via a Web browser. In step 925, the user copies the content (i.e., text) of the order confirmation email (from within the email application) and pastes it in the designated Web form on the site. Finally, in step 930, the user submits the form (e.g., by clicking a button). The method of FIG. 9 implements step 610 of FIG. 6A as step 935, and step 615 of FIG. 6A as steps 940-960. In step 935, the system's front-end receives the submitted text. The remaining steps, 940-960, are generally identical to steps 735-750 of FIG. 7, with one slight difference. If the method reaches step 955, there is no need to send an email to the user. The user is already on the Web site, so the system may respond to the submission of the Web form by displaying a Web page that requests the user to complete any missing information.

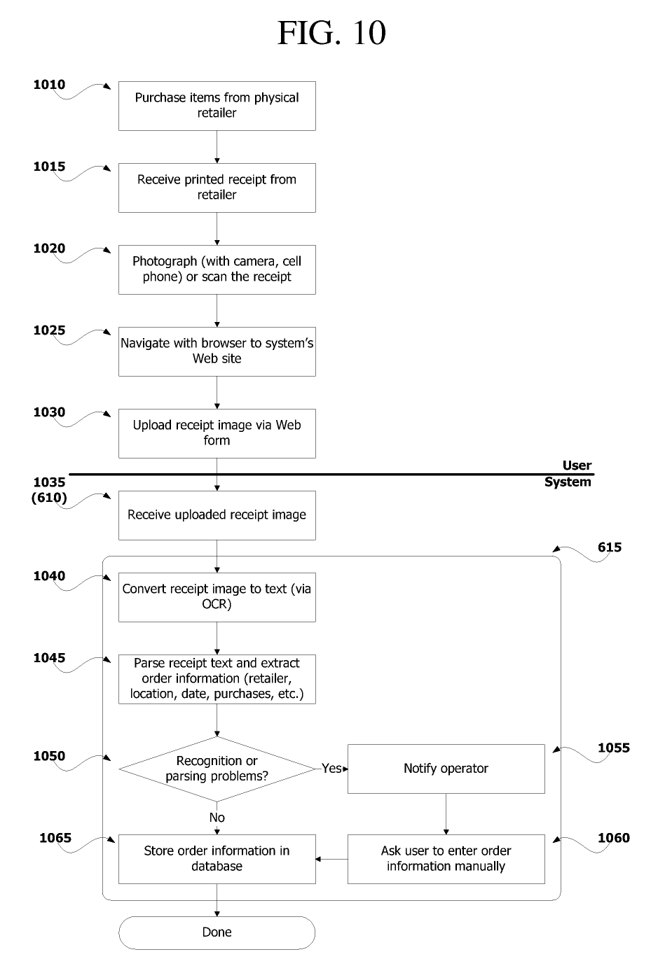

FIG. 10, to which reference is now made, is a block diagram of a method for collecting order statements in which the user creates a digital copy of a printed receipt and submits it to the system via a Web site, operative in accordance with an embodiment of the present invention. The advantages of this method over the method of FIG. 8 are similar to the advantages of the method of FIG. 9 over the method of FIG. 7 (e.g., a user can provide additional information, such as alternative contact details). In step 1010, the user purchases one or more items from a physical retailer. In step 1015, upon completing the transaction, the user is handed a printed receipt, which contains the information required by system 510. In step 1020, the user creates a digital copy of the printed receipt by photographing or scanning it. In step 1025, the user browses to the system's Web site, and in step 1030, submits the receipt image. The method of FIG. 10 implements step 610 of FIG. 6A as step 1035, and step 615 of FIG. 6A as steps 1040-1065. In step 1035, Web server 552 receives the image. In step 1040, the system converts the receipt image to a textual representation via OCR. The remaining steps, 1045-1065, are generally identical to steps 940-960 of FIG. 9.

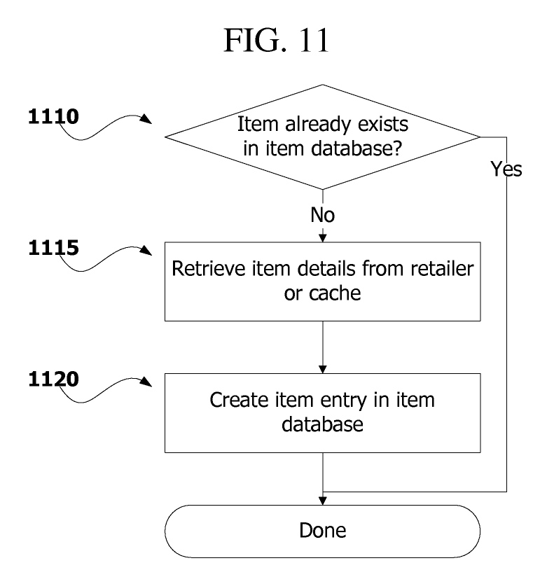

FIG. 11, to which reference is now made, is a block diagram of a method for adding a new item to the item database 563, operative in accordance with an embodiment of the present invention. This method may be used by item locator 545 after front-end 550 receives an order statement and extracts the order information. That is, this method may be executed at any time after the front-end completes step 615 of FIGS. 6-10. In step 1110, the item locator checks if the item associated with the item identifier (which was extracted from the order statement, and may be unique to that specific retailer) already exists in the item database. If it does, the method terminates. Otherwise, it proceeds to step 1115, in which the item locator retrieves the retailer's listing of the item. There are several ways in which the item locator can find the URL of the listing based solely on the item identifier:
1) If the retailer offers a Web page for each item, and the URL of an item's Web page contains the item's identifier (i.e., the name or number of the product, as specified in the retailer's order confirmation email or receipt), then the item locator may simply construct the URL of the item's Web page.
2) If the retailer's Web site or Web service offer search functionality, the response of the retailer's search engine to a query containing the item identifier may include the URL of the retailer's Web page for that item, or a hint that the item locator may use to retrieve that item's information via the retailer's Web service.
3) If the retailer's Web site is indexed by a third-party search engine, such as Google, then the item locator may utilize that search engine in retrieving the item's information, in a manner similar to the previous option. The item locator sends a query to the search engine containing the retailer-specific item identifier. The query may also include the name of the retailer or a special instruction to search only that retailer's Web site (e.g., by specifying “site: bestbuy.com” in a query to Google, only results from bestbuy.com are returned). The item locator then checks if the search engine's response includes the URL of the retailer's listing for the item.
4) The item identifier may be found in Web cache 562, which contains raw copies of the Web pages from the Web sites of the supported retailers. In this case, the item locator can retrieve the necessary item's information, or the location of such information (e.g., the URL of the item's Web page on the retailer's Web site), from the Web cache (or an index of the Web cache).

In step 1120, the item locator creates a new entry in the item database. It may store not only the item identifier, but also the details of the item, as retrieved from the retailer's listing of that item.

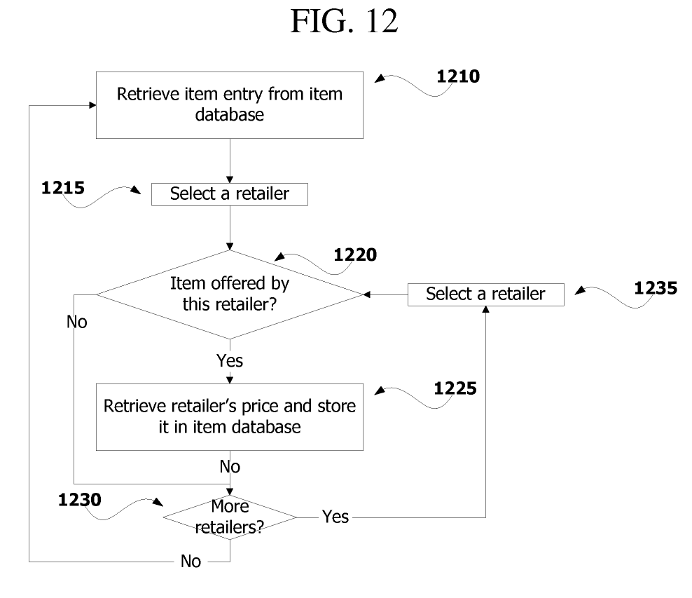

FIG. 12, to which reference is now made, is a block diagram of a method for keeping the item database up to date with the most recent (i.e., current) prices, operative in accordance with an embodiment of the present invention. This method generally continually iterates through the entire item database, processing all relevant items in the database. In step 1210, item tracker 544 retrieves an item from item database 563. In steps 1215-1235, the item tracker retrieves the current price of the item from each of the retailers that are supported by the system (which offer that item). In step 1215, a retailer is selected (according to some order, which is insignificant). In step 1220, if the item is offered by the current retailer, the system proceeds to step 1225. Otherwise, it proceeds to step 1230. In step 1225, the item's price is retrieved from the current retailer and updated (if appropriate) in the item database. In step 1230, if there are more retailers, the system proceeds to step 1235, in which the next retailer is selected. Otherwise, the system returns to step 1210, in which another item is selected from the item database. The entire process is then repeated for all retailers of that item and then for all other items. It is hereby noted that other ordering of these steps is possible and within the scope of the present invention. Furthermore, an embodiment of the present invention may not support matching price protection, in which case only steps 1210 and 1225 (for the retailer from which the item was purchased) would be required, because there would be no need to check retailers other than the one from which the item was purchased.

FIG. 13, to which reference is now made, is a block diagram of a method for checking for savings opportunities by taking advantage of a retailer's price protection policy, operative in accordance with an embodiment of the present invention. This method is a possible implementation of step 625 of FIG. 6B, and may be carried out by opportunity detector 543. In steps 1315-1330, the opportunity detector checks if it possible to exploit the retailer's non-matching protection (i.e., refunding the difference between the original price and the current price at the same retailer). In steps 1335-1365, the opportunity detector looks for opportunities to exploit the retailer's matching protection (i.e., refunding the difference between the original price and the current price at a competitor). The method starts at step 1310, in which the system determines what price protection policy applies to the current purchase on hand. This may depend on the order date, because a retailer's price protection policy may change, and it is important to use the price protection policy that applies to the purchase being processed. In step 1315, if the retailer provides non-matching protection, the system proceeds to step 1320. Otherwise, it jumps to step 1335. In step 1320, the system checks if all the conditions set forth in the retailer's price protection policy with regard to non-matching protection are satisfied. If they are, the system proceeds to step 1325. Otherwise, it jumps to step 1335. In step 1325, the system checks if the retailer is currently offering the item for less than the original price. If it is, the system proceeds to step 1330, in which the system records the user's opportunity to take advantage of the retailer's non-matching protection (at the end of the entire process, in step 1370, the user is notified of one or more opportunities that were found). Otherwise, it proceeds directly to step 1335, in which evaluation of the retailer's matching protection begins.

In step 1335, if the retailer's price protection policy includes matching protection, the system proceeds to step 1340. Otherwise, it jumps to step 1370, where any opportunities related to non-matching protection are reported to the user. In steps 1340-1365, the system iterates over the supported retailers (except for the original retailer—the one from which the user originally purchased the item). In step 1340, the system selects a retailer. In step 1345, the system checks if all the conditions set forth in the retailer's price protection policy with regard to matching protection are satisfied. If they are, the system proceeds to step 1350. Otherwise, it jumps to step 1360. In step 1350, the system checks if the current retailer's price for this item is lower than the original price that was paid for the item. The exact details of this step may depend on the original retailer's price protection policy. For example, the price protection policy of Zappos.com, shown in FIG. 1, explicitly mentions that taxes (if any) and shipping charges (if applicable) are included when calculating the price difference. However, the price protection policies of some other retailers do not consider shipping charges when deciding whether to match a competitor's price. In step 1350, if the system determines that the item's current price at this retailer is less than what the user originally paid, the system proceeds to step 1355, in which it records the user's opportunity to request a refund. Otherwise, the system proceeds directly to check step 1360. If there are more retailers to check (for the purchase that is being processed in the current execution of the method of FIG. 13), the system continues to step 1365, in which the next retailer is selected (according to some insignificant order). Otherwise, the system proceeds to step 1370, in which it reports the savings opportunities that were found, if any, to the user, and the method terminates. Step 1370 is generally equivalent to steps 630 and 635 of FIG. 6B.

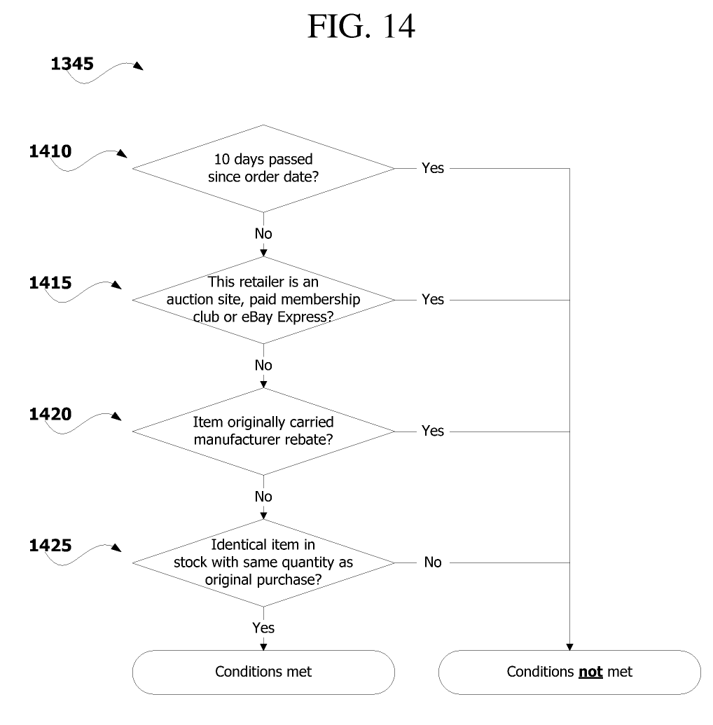

FIG. 14, to which reference is now made, is a block diagram of an exemplary method for checking if Zappos.com will match a competitor's price on a purchased item, operative in accordance with an embodiment of the present invention. This method illustrates an exemplary execution of step 1345 of FIG. 13, comprising the steps that opportunity detector 543 may take in order to check if the conditions of an exemplary specific retailer's price protection policy are met. This method relates to the matching protection (but not to the non-matching protection) of Zappos.com. Referring back briefly to the Zappos.com's protection policy shown in FIG. 1, the retailer offers price protection for 10 days after the purchase is made. Furthermore, it requires the item to be in stock at the competitor, in the same quantity as the original purchase. In addition, it does not match auction sites, paid membership clubs or eBay Express. Furthermore, price protection does not apply to items sold with a manufacturer's rebate. Referring to FIG. 14, in step 1410, the opportunity detector checks if more than 10 days have passed since the item was purchased. If the item was purchased during the last 10 days, the system proceeds to step 1415. Otherwise, it concludes that Zappos.com will not match this retailer's price. In step 1415, if the current retailer is eBay Express or belongs to one of the categories that Zappos.com does not match (auction sites and paid membership clubs), the system concludes that Zappos.com will not match this retailer. Otherwise, the system proceeds to step 1420, in which it checks if the purchased item carried a manufacturer's rebate. This information may be available in item database 563 or order database 564, depending on the implementation of the system. If the item carried a manufacturer's rebate, it is not eligible for price protection according to Zappos.com's policy, so the system does not continue evaluating other conditions. In step 1425, the system checks if the current retailer has the exact same item and quantity in stock, in which case the system concludes that all of the conditions are satisfied, and Zappos.com will agree to refund the difference between the competitor's current price and the price that the customer originally paid Zappos.com for the item. Otherwise, the system concludes that Zappos.com will not match the retailer's price on this item.

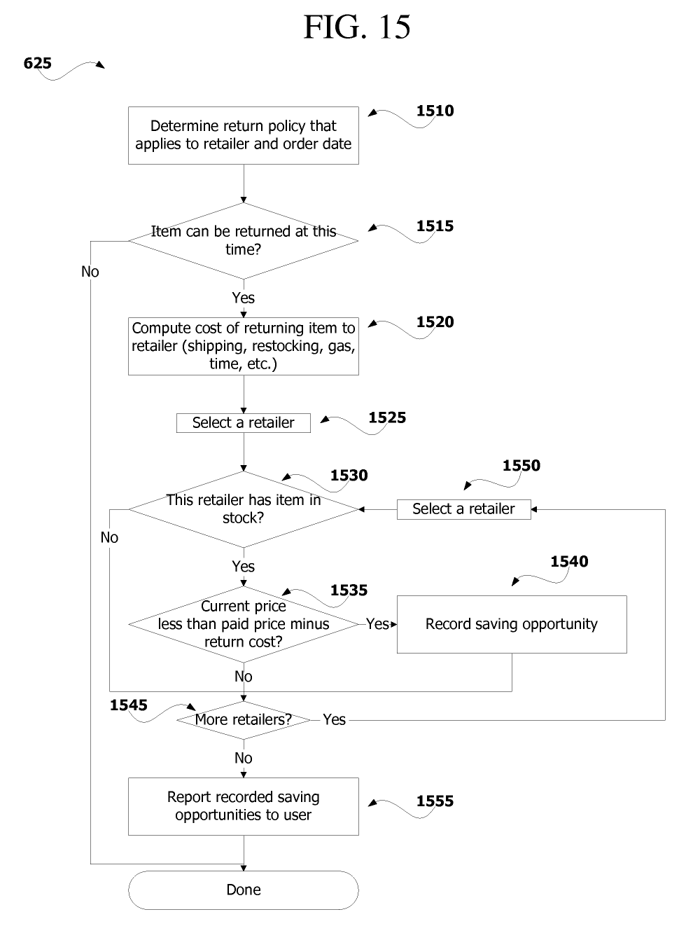

FIG. 15, to which reference is now made, is a block diagram of a method for checking for savings opportunities by taking advantage of a retailer's return policy, operative in accordance with an embodiment of the present invention. In some cases, a customer can benefit from returning a purchased product to the original retailer and then re-purchasing it, either from the same retailer or a different one. The method of FIG. 15 implements steps 625, 630 and 635 of FIG. 6B. In step 1510, opportunity detector 543 determines what return policy applies to the purchase on hand. This may depend on the order date, because a retailer's return policy can change. In step 1515, if the item cannot be returned, the procedure terminates. There are many possible reasons why it might not be possible to return an item. For example, it may be beyond the allowed return period. Furthermore, some items simply cannot be returned according to a retailer's policy. In step 1520, the system calculates the total cost to the user of returning the item. For some retailers and items, the cost may be small. For instance, Zappos.com provides free return shipping, so the cost comprises the user's time, but not shipping expenses. However, in some cases returning a product in accordance with the retailer's return policy may involve more significant costs. For example, the customer may need to pay the return shipping expenses, or perhaps a restocking fee. Furthermore, if the customer is required to physically visit one of the retailer's locations in order to return an item, the transportation cost (e.g., gas) may also be considered in addition to the inconvenience and lost time. While some costs are easy to quantify (e.g., shipping expenses, restocking fees), other costs (e.g., lost time) may be more difficult to quantify. There are several ways in which the system may address this difficulty. One option is to simply ignore such costs. Another option is to allow the user to provide some guidance on how to quantify such costs. This may be beneficial because, for instance, one customer might be willing to spend an hour to save $5, whereas another customer might be willing to spend an hour only if the benefit is at least $100. Yet another way in which the system may address this difficulty is by ignoring such costs while allowing users to specify some threshold so that the system will only notify them of savings opportunities that generate a profit that is greater than the threshold.

Referring to FIG. 15, in steps 1525-1550, the system checks whether the user can benefit from returning the product and re-purchasing it from any one of the retailers supported by the system. The loop illustrated by steps 1525-1550 includes the original retailer as well, so there are no special steps dedicated to re-purchasing the product from the same retailer. In step 1525, the system selects a retailer. In step 1530, the system checks if the selected retailer currently has the item in stock. There is no point in suggesting that the user return the product and then re-purchase it from a retailer that does not have the item in stock. If the retailer does indeed have the item in stock, the system proceeds to step 1535. Otherwise, it proceeds to step 1545. In step 1535, the system checks if the current price of the item at this retailer, including any related expenses (e.g., tax, shipping), is less than the original price that the user paid. If the system utilizes the threshold mechanism described herein, the system further checks that the difference is not less than the threshold. If these conditions are met, the system proceeds to step 1540, in which the opportunity to exploit the original retailer's return policy is recorded so that it can be reported to the user. Otherwise, it proceeds directly to step 1545. In step 1545, if there are additional retailers that have not been checked, the system selects the next retailer (according to some insignificant order) in step 1550 and repeats the process in steps 1530-1550. Otherwise, the system proceeds to step 1555, in which it reports the savings opportunities that were found to the user, and the method terminates. It is worth noting that a system of the present invention may not have the capability to consider the re-purchasing of an item from a different retailer (i.e., the system may not be capable of correlating between items from different retailers), in which case steps 1525, 1545 and 1550 would not be necessary, and steps 1530-1535 would relate to the same retailer as steps 1510-1520 (i.e., the retailer from which the item was originally purchased).

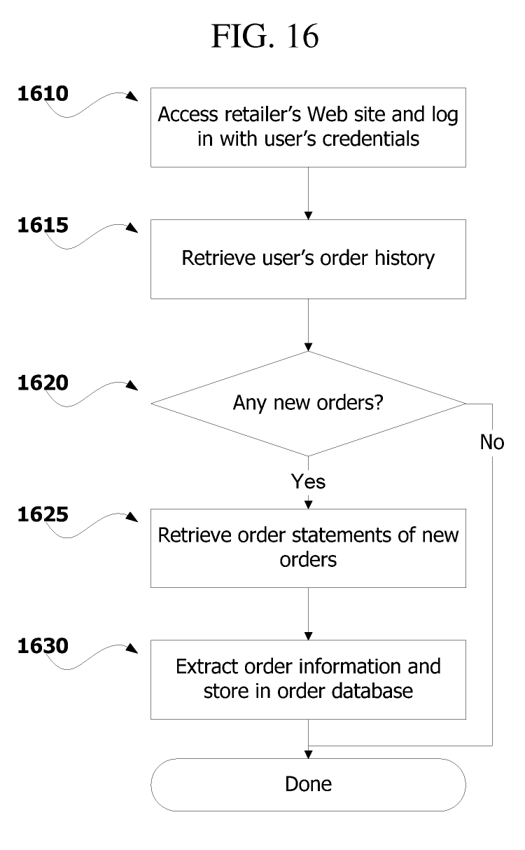

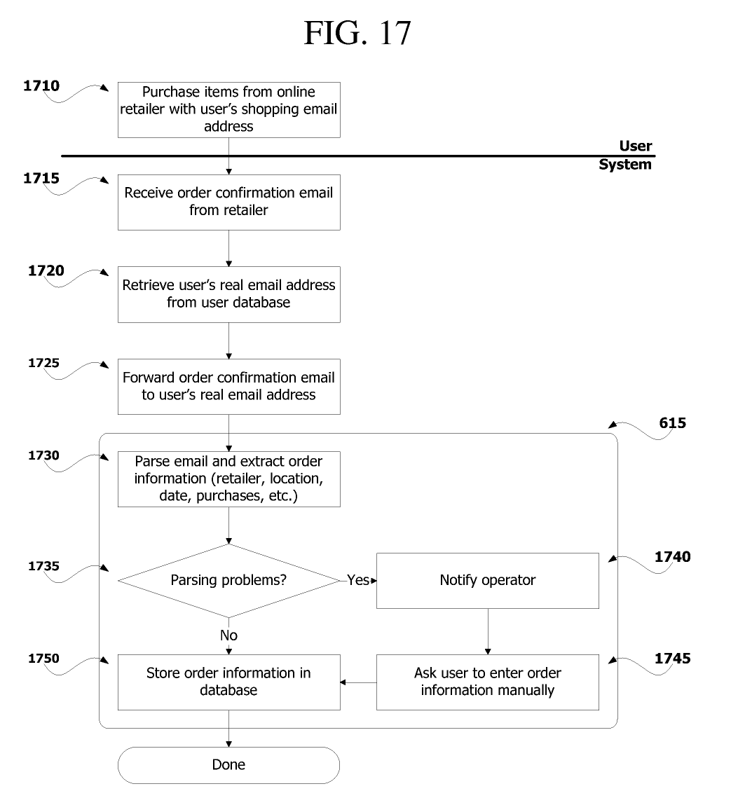

FIGS. 16-17 illustrate exemplary procedures for collecting order information in which users are not required to perform any additional steps after purchasing from retailers. The user may be required to register with system 510. During the registration process, the user may provide the system with information that will allow the system to learn about new orders without requiring the user to explicitly provide order statements to the system.

FIG. 16, to which reference is now made, is a block diagram of a method for automatically collecting order statements by accessing a user's online account, operative in accordance with an embodiment of the present invention. Users may need to provide their credentials for specific retailers to the system so that the system can access their accounts at the desired retailers. For example, users that are interested in applying price protection to their Amazon.com orders may be required to provide their Amazon.com credentials (e.g., username and password). The system would then be able to use such credentials to access their accounts on a regular basis in order to look for new orders which may be monitored for savings opportunities. In step 1610, system 510 accesses a retailer's Web site (or Web service) and logs into a user's account with the user's credentials. In step 1615, the system retrieves the user's history of orders. In step 1620, the system checks if there are any orders that were not retrieved in a previous execution of this method. If such orders are found, the system proceeds to step 1625. Otherwise, the method terminates. In step 1625, the system retrieves the data pertaining to all orders that were not previously retrieved. The method of FIG. 16 implements step 615 of FIG. 6A as step 1630, in which the system parses the data, extracts the order information and stores it in orders database 564. The method of FIG. 16 is executed on a regular basis for all user-retailer combinations for which the system is able to retrieve the user's orders from the retailer's Web site or Web service.

FIG. 17, to which reference is now made, is a block diagram of a method for collecting order statements in which the system receives the retailer's order confirmation email directly from the retailer, operative in accordance with an embodiment of the present invention. This procedure enables the system to receive data pertaining to new orders of users, without requiring users to grant the system access to their accounts at the retailers. To make this possible, during an earlier registration process the user selects a custom and unique email address associated with the system of the present invention. This email address is herein referred to as the user's “shopping email address.” For example, assuming the domain name afteryoubuy.com is mapped to the system, a user named John Doe may select the shopping email address jdoe@afteryoubuy.com. Alternatively, the user's shopping email address may be automatically set to username@afteryoubuy.com, where username is simply the username that the user selected when registering with the system. While registering with the system, users may also be required to provide their real email addresses, so if John Doe's real email address is jdoe@gmail.com, he would provide that address. After this initial step, the system knows the shopping email address and real email address of each user (the mapping is stored in user database 565). When purchasing items online, a user provides the shopping email address to the online retailer rather than his or her real email addresses. The retailer then sends the order confirmation email to the user's shopping email address, which is associated with the system of the present invention, hence the email arrives at the system. The system can then extract the necessary information from the email and may forward the email to the user's real email address. In addition, the system may allow users to send emails using their shopping email addresses. This may be required for retailers that require users to communicate with them using the email addresses that the retailers have on file for their users.

In step 1710, the user purchases items from an online retailer using his or her shopping email address (e.g., jdoe@afteryoubuy.com). The retailer sends out an order confirmation email that the system receives (step 1715). The “To” field of the email comprises the user's shopping email address (e.g., jdoe@afteryoubuy.com). Upon receiving the order confirmation email, the system extracts the user's shopping email address from the “To” field of the email. In step 1720, the system uses the shopping email address to find the user's real email address in user database 565. In step 1725, the system optionally forwards the order confirmation email to the user's real email address (e.g., jdoe@gmail.com). In steps 1730-1750 (step 615 of FIG. 6A), the system processes the email, as in steps 730-750 of FIG. 7.

In another embodiment of the present invention, the system may retrieve order confirmation emails from standard email accounts, so that users do not need to establish dedicated email addresses (i.e., shopping email addresses) in order to use the system in a transparent way. The system may require users to provide their credentials in advance, so that it can access their accounts periodically to check for new incoming order confirmation emails. This method has a disadvantage, because users are required to expose their personal email account credentials to the system, and many users may be reluctant to do so due to security and privacy concerns.

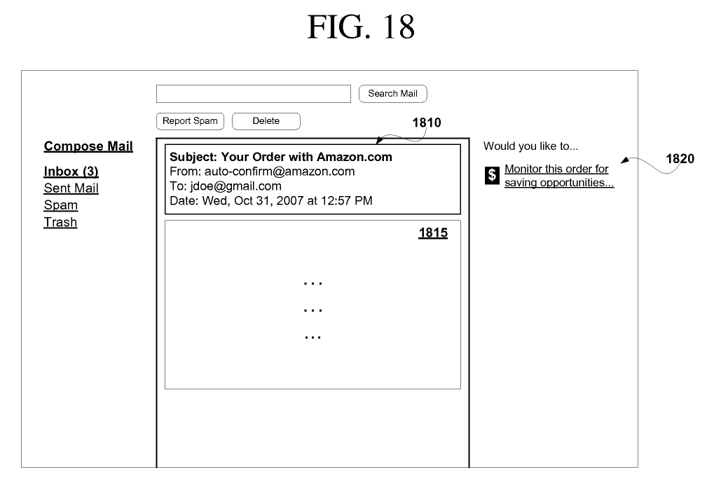

In yet another embodiment of the present invention, the system is integrated with an email service, such as a Web-based email service (e.g., Google Gmail). System 510, in this embodiment, may be a component in a larger system that implements the email service. Since the email service has unrestrained access to the email accounts of its users, such integration enables system 510 to obtain order confirmation emails sent to the users without explicitly asking them to hand over their credentials (and, of course, without requiring them to explicitly provide the order confirmation emails, as required by the methods of FIGS. 7-10). FIG. 18, to which reference is now made, is an illustration of an exemplary Web-based email service operative in accordance with an embodiment of the present invention. FIG. 18 illustrates what a user of the email service may see while viewing an order confirmation email from an online retailer named Amazon.com. Area 1810 comprises the primary attributes of the email, such as the subject (Your Order with Amazon.com), the “From” and “To” addresses and the date. Area 1815 comprises the actual body of the email, which may be similar to the electronic receipt shown in FIG. 4. Based on either the attributes (e.g., subject, “From” address) or the body of the email, the system may determine whether the email is an order confirmation email. In FIG. 18, the system determined that the current email (with the subject “Your Order with Amazon.com”) is indeed an order confirmation email, so it provided the user with link 1820 to enable monitoring for the order. Once the user clicks the link, the system begins monitoring the purchases in the order, seeking opportunities to exploit the retailer's price protection and/or return policies. It is worth noting that FIG. 18 is only one example of how an email service, such as Google Gmail, may utilize the methods of the present invention, and there are clearly other ways to do so. For example, instead of notifying the user and presenting link 1820 to enable monitoring, the email service may automatically begin monitoring the purchases of an order once it receives the corresponding order confirmation email.

The system of the present invention may be able to extend its service beyond the procedures described herein by automatically requesting refunds from some retailers, in accordance with their price protection policies. Retailers may have specific requirements on how their customers should request refunds. For example, a retailer may require a customer to send a request for a refund from the same email address that the customer used for the original order. In such cases, if a shopping email address was used, or if the system has access to the email account that was used, the system may automatically send an email to the retailer from that email account. Alternatively, some retailers may require that requests for refunds be submitted through their Web sites. If the user's credentials are required in order to submit a request for refund on a retailer's Web site, and system has those credentials, the system can simply submit such a request through the retailer's Web site.

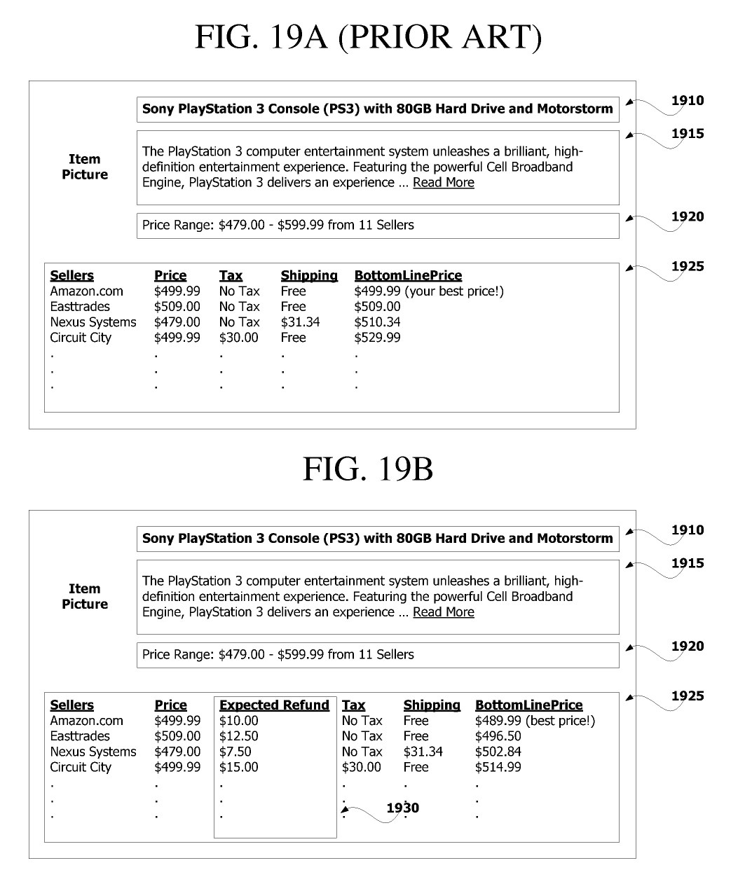

FIGS. 19A and 19B, to which reference is now made, are illustrations of price comparison Web sites, wherein FIG. 19A uses a system of the prior art and FIG. 19B uses an embodiment of the present invention. FIG. 19A shows an exemplary Web page of an item (Sony PlayStation 3), as generated by PriceGrabber.com, a popular price comparison service. Area 1910 comprises the item's name, while area 1915 comprises its description. Area 1920 displays the range of prices for the item, and may be considered a summary of the Price column of the comparison table. Area 1925 comprises a comparison table which compares the pricing of the item among the retailers that offer it. FIG. 19A shows a comparison between Amazon.com, Easttrades, Nexus Systems and Circuit City. The table may comprise not only the published price at each retailer, but also additional attributes, such as the applicable taxes, shipping expenses and “bottom-line price.” However, the price protection and return policies of the retailers are not comprised in the comparison.

FIG. 19B shows an equivalent comparison table generated in accordance with an embodiment of the present invention. Areas 1910-1920 are the same as in FIG. 19A. Area 1925, comprising the comparison table, now comprises an additional criterion (column), the expected refund. This column is shown in area 1930. Unlike prior art systems, by using various data mining techniques and heuristics on the data accumulated by system 510 over time, the price comparison service may determine an expected refund for the item at each retailer. Inclusion of an expected refund may allow more sophisticated price comparisons. Many factors can affect this calculation, such as the historical price volatility of items at the retailer. In this example, the price comparison service includes the expected refund in the calculation of the bottom-line price (it may subtract the expected refund from the “original” bottom-line price). It is worth noting that the price comparison service may display some other indication related to the retailers' price protection and/or return policies, other than the expected refund. For example, the price comparison service may indicate how likely it is that the user would receive a refund on the item in the future (if he or she would purchase it from that retailer). The likelihood may be represented in many different ways. For example, it may be represented by an estimated probability (e.g., “there is a 25% chance that you will receive a refund from this retailer”). Alternatively, several discrete “likelihood categories” may be used, such as “high,” “medium” and “low.”

Although the present invention has been described in terms of various embodiments, it is not intended that the invention be limited to these embodiments. Modifications within the spirit of the invention will be apparent to those skilled in the art. For example, the system may help consumers take advantage of price protection policies, but not return policies, or vice versa. It may help consumers take advantage of non-matching protection, but not matching protection. It may consider opportunities for returning an item and re-purchasing it from the same retailer, but not from different retailers. Also, in some cases retailers may combine multiple orders into one statement, such as an order confirmation email. This can happen when, for example, different items are shipped by different suppliers or have different shipping dates. Therefore, an order statement may, in fact, contain the information of multiple orders. Also, although some of the description refers to Web sites of online retailers, some retailers may expose Web services which the system may utilize instead of accessing their Web sites. It is also worth noting that although the description often uses the terms user and customer interchangeably, it is possible that the person interacting with the system is not the person that actually purchased the items. For example, if someone purchases items from a retailer, a family member of that person may actually submit the order statement to the system. The terms order and transaction are also used interchangeably in the description. The term order is used to refer not only to the purchasing of items from online retailers, but also to transactions at physical retailers. The scope of the present invention is defined by the claims that follow.

We claim:

1. A method, performed by a computer-based system, for identifying savings opportunities, the method comprising:
having an order statement;
extracting order information from the order statement, the order information comprising a retailer identifier corresponding to a retailer, an order date and at least one purchase, each purchase comprising an item identifier and a price that was paid for the item; and
checking if a savings opportunity exists on any of the items in the order information.

2. The method of claim 1 wherein said checking comprises considering any of a return policy of the retailer and a price protection policy of any of the retailer and at least one other retailer.

3. The method of claim 2 wherein the order statement is any of an order confirmation email and a digital copy of a printed receipt.

4. The method of claim 3 wherein said having comprises the retailer sending the order confirmation email to any of an email address controlled by a user and an email address controlled by the computer-based system.

5. The method of claim 4 wherein said having further comprises receiving the order confirmation email forwarded by the user from the email address controlled by the user.

6. The method of claim 4 wherein said having further comprises:
accessing an email account corresponding to the email address controlled by the user; and
retrieving the order confirmation email.

7. The method of claim 6 wherein said having further comprises receiving credentials from the user,
wherein said accessing further comprises authenticating with the credentials.

8. The method of claim 4 wherein said having further comprises the computer-based system forwarding the order confirmation email received from the retailer at an email address controlled by the computer-based system, to an email address controlled by the user.

9. The method of claim 4 wherein said retailer sending an order confirmation email to an email address controlled by the computer-based system further comprises the user establishing the email address on a Web site associated with the computer-based system.

10. The method of claim 3 wherein said extracting comprises performing optical character recognition (OCR) on the digital copy.

11. The method of claim 3 wherein the order statement is an order confirmation email and said computer-based system is a Web-based email service.

12. The method of claim 1 and further comprising requesting information from the user if said extracting does not provide all information needed.

13. The method of claim 1 wherein said having comprises receiving the order statement on any of a Web site and a Web service associated with the computer-based system.

14. The method of claim 1 wherein said having comprises retrieving the order statement from any of a Web site and a Web service associated with the retailer.

15. The method of claim 14 and further comprising receiving credentials from a user,
wherein said retrieving comprises authenticating with the credentials.

16. The method of claim 1 wherein said checking comprises retrieving the current price of the item from any of a Web site and a Web service of any of the retailer and at least one other retailer.

17. The method of claim 1 wherein said checking comprises retrieving the current price of an item from a database that contains up-to-date prices of items at different retailers.

18. The method of claim 1 and further comprising the computer-based system requesting the retailer to provide a refund to the customer if any savings opportunity exists.

19. A method, performed by a computer-based system, for identifying savings opportunities, the method comprising:
having purchase information, wherein the purchase information comprises a retailer identifier corresponding to a retailer, an item identifier corresponding to an item, a purchase date and a price that was paid for the item; and
checking if the customer can save money by returning the item to the retailer and re-purchasing it from any retailer.

20. The method of claim 19 wherein said checking further comprises considering costs associated with returning the item to the retailer.

21. A method, performed by a computer-based system, for providing a price comparison of an item, the method comprising:
determining the price of an item at multiple retailers; and
providing a price comparison,
wherein the price comparison comprises, for each of the multiple retailers, a retailer identifier, the price of the item and additional information related to any of the price protection policy and the return policy of the retailer.

22. The method of claim 21 wherein the additional information is an estimated future refund.

23. The method of claim 22 wherein the expected refund is computed based on refunds that customers were entitled to receive from the retailer in the past.

24. The method of claim 21 wherein the additional information comprises the likelihood that the customer will be entitled to a refund on the item in the future.

25. A computer-based system for identifying savings opportunities, the system comprising:
a front-end component to receive an order statement and to extract order information from the order statement;
a database for storing the order information; and
an opportunity detector component to check if a savings opportunity exists for any of the items in the database,
wherein the order information comprises a retailer identifier corresponding to a retailer, an order date and at least one purchase, each purchase comprising an item identifier and a price that was paid for the item.

26. The system of claim 25 wherein said front-end component comprises an email server and said order statements is an order confirmation email.

27. A computer-based system for identifying savings opportunities comprising:
an extractor to extract order information from an order statement, the order information comprising a retailer identifier corresponding to a retailer, an order date and at least one purchase, each purchase comprising an item identifier and a price that was paid for the item; and
a checker to determine if a savings opportunity exists on any of the items in the order information.

28. The system of claim 27 wherein the order statement is received from the retailer at any of an email address controlled by a user and an email address controlled by the computer-based system.

29. The system of claim 28 wherein the order statement is received from the user from an email address controlled by the user.

30. The system of claim 28 wherein the order statement is received at an email address controlled by the computer-based system wherein the user established the email address on a Web site associated with the computer-based system.

31. The system of claim 27 wherein the order statement is an order confirmation email and the computer-based system is a Web-based email service.

32. The system of claim 27 and further comprising a user interface to request information from the user if said extractor does not provide all information needed.

33. The system of claim 27 wherein said checker considers costs associated with returning the item to the retailer.
